(19) United States
(12) Patent Application Publication
(10) Pub. No.: US 2013/0294402 A1
(43) Pub. Date: Nov. 7, 2013

(54) METHOD AND DEVICE FOR TRANSMITTING/RECEIVING POSITIONING REFERENCE SIGNAL IN HETEROGENEOUS COMMUNICATION SYSTEM

(71) Applicant: Sungjun Yoon, Seoul (KR)

(72) Inventor: Sungjun Yoon, Seoul (KR)

(73) Assignee: PANTECH CO LTD, SEOUL (KR)

(21) Appl. No.: 13/979,282

(22) PCT Filed: Jan. 13, 2012
(86) PCT No.: PCT/KR12/00332

§ 371 Date: Jul. 11, 2013

(30) Foreign Application Priority Data
Jan. 14, 2011 (KR) 10-2011-0004157

(51) Int. Cl. H04W 72/08

(52) U.S. Cl. CPC H04W 72/082
USPC 370/330

(57) ABSTRACT

The present invention relates to a method and a device for transmitting/receiving a positioning reference signal (PRS) in a wireless communication system, in particular, a heterogeneous communication system. In the heterogeneous communication system having one or more macro cells and one or more non-macro cells located in each of the macro cells, the non-macro cells or the macro cells transmit the PRS by forming and transmitting respective PRS patterns in a time-frequency resource area that does not duplicate a time-frequency resource area where corresponding macro cells or corresponding non-macro cells transmit the PRS. The present invention can be used to minimize the influence of interference between base stations of different forms in the heterogeneous communication environment, and promote enhancement of accuracy in measuring the position of a user equipment.

### CROSS-REFERENCE TO RELATED APPLICATIONS

This application is the National Stage Entry of International Application PCT/KR2012/000332, filed on Jan. 13, 2012, and claims priority from and the benefit of Korean Patent Application No. 10-2011-0004157, filed on Jan. 14, 2011, all of which are incorporated herein by reference for all purposes as if fully set for herein.

### BACKGROUND

1. Field

The present invention relates to a wireless communication system, and more particularly to a method and a device for transmitting/receiving a Positioning Reference Signal (PRS) in a wireless communication system.

2. Discussion of the Background

With the progress of communication systems, consumers such as companies and individuals have required wireless terminals supporting various services.

Current mobile communication systems such as a 3^{rd} Generation Partnership Project Long Term Evolution (3GPP LTE) and a 3GPP LTE Advanced (LTE-A), need to develop a technology for a system capable of transmitting a large amount of data coming close to that transmitted through a wired communication network, as a high-speed and high-capacity communication system capable of transmitting and receiving various data such as images and wireless data beyond voice-oriented services. In addition, the current mobile communication systems require an appropriate error detection scheme which can improve system performance by minimizing information loss and increasing system transmission efficiency.

Further, for several current communication systems, various reference signals have been and are being proposed in order to provide information on a communication environment and the like to counterpart apparatuses in uplink or downlink.

Among the various reference signals, in order to measure a location of a User Equipment (UE), each cell or Base Station (BS) transmits a Positioning Reference Signal (PRS) to the UE. Then, the relevant UE receives the PRS from each BS, which has been transmitted during a particular time period, and measures the location thereof.

Up to now, a communication system such as the LTE adopts a configuration for transmitting a PRS in an N number of consecutive subframes on a particular cycle (i.e., T subframes).

However, in a heterogeneous communication environment where each macro cell includes a non-macro cell such as a pico cell or a femto cell, a UE which is located in the particular non-macro cell, receives signals transmitted by the macro cell as well as by the non-macro cell. Accordingly, when a PRS is defined by the existing technology considering only a macro cell, the effects of interference between the non-macro cells in different forms, such as a pico cell and the like, can increase the probability of error in receiving a PRS. It is also impossible to expect potential benefits which can be obtained when a PRS is transmitted by each of BSs in different forms, such as a pico cell and the like.

Accordingly, the present invention is intended to propose a method and a device for transmitting/receiving a PRS, which can minimize the effects of interference between BSs in different forms and thereby can improve accuracy in measuring a location of a UE, in a heterogeneous communication environment.

### SUMMARY

Therefore, an aspect of the present invention is to provide a method and a device for transmitting/receiving a positioning reference signal in a wireless communication system.

Another aspect of the present invention is to provide a method and a device for transmitting/receiving a positioning reference signal, which can accurately measure a location of a user equipment in a heterogeneous communication system where a macro cell and a non-macro cell exist.

Still another aspect of the present invention is to provide a method and a device for allocating positioning reference signals from a related macro cell and a related pico cell to resource regions, which do not overlap, in allocating a cell-specific positioning reference signal to a resource region in a heterogeneous communication environment where the macro cell and the pico cell exist.

In accordance with an aspect of the present invention, there is provided a method for transmitting a Positioning Reference Signal (PRS) in a communication system where one or more macro cells exist and one or more non-macro cells included in the one or more macro cells exist. The method includes: generating a PRS sequence unique to each macro cell or each non-macro cell, by each macro cell or each non-macro cell; allocating or mapping the generated PRS sequence to a time-frequency resource area by using PRS transmission information, by each macro cell or each non-macro cell, wherein each macro cell or each non-macro cell allocates or maps the generated PRS sequence to the time-frequency resource area which does not overlap a PRS allocation resource area of a corresponding non-macro cell or a corresponding macro cell; generating an OFDM signal including the allocated or mapped PRS sequence, by each macro cell or each non-macro cell; and transmitting the generated OFDM signal, by each macro cell or each non-macro cell.

In accordance with another aspect of the present invention, there is provided a device for transmitting a Positioning Reference Signal (PRS) in a communication system where one or more macro cells exist and one or more non-macro cells included in the one or more macro cells exist. The device includes: a PRS sequence generator for generating a PRS sequence unique to each macro cell or each non-macro cell; a PRS resource allocator for allocating or mapping the generated PRS sequence to a time-frequency resource area by using PRS transmission information, and allocating or mapping the generated PRS sequence to the time-frequency resource area which does not overlap a PRS allocation resource area of a corresponding non-macro cell or a corresponding macro cell; and an OFDM processor for generating an OFDM signal including the allocated or mapped PRS sequence and transmitting the generated signal.

In accordance with still another aspect of the present invention, there is provided a method for receiving a Positioning Reference Signal (PRS) by a user equipment in a communication system where one or more macro cells exist and one or more non-macro cells included in the one or more macro cells exist. The method includes: receiving and demodulating an OFDM signal transmitted while including a PRS sequence mapped to a time-frequency resource region which does not overlap a resource region allocated a PRS sequence of a corresponding macro cell or a corresponding non-macro cell; extracting PRS sequences of one or more cells among the one or more macro cells and the one or more non-macro cells; and estimating location information of the user equipment by using the extracted PRS sequences.

In accordance with yet another aspect of the present invention, there is provided a device for receiving a Positioning Reference Signal (PRS) in a user equipment in a communication system where one or more macro cells exist and one or more non-macro cells included in the one or more macro cells exist. The device includes: a reception processor for receiving an OFDM signal transmitted while including a PRS sequence mapped to a time-frequency resource region which does not overlap a resource region allocated a PRS sequence of a corresponding macro cell or a corresponding non-macro cell; a PRS sequence extractor for demapping information allocated to each resource element of the received OFDM signal, and extracting a PRS sequence of a cell which has transmitted the relevant signal; and a location measurement unit for estimating location information of a user equipment by using the one or more extracted PRS sequences.

In accordance with still yet another aspect of the present invention, there is provided a method for transmitting a Positioning Reference Signal (PRS) in a heterogeneous communication system having one or more macro cells and one or more non-macro cells located within each macro cell. In the method, each of the one or more non-macro cells or each of the one or more macro cells forms a PRS pattern thereof and transmits a PRS in a time-frequency resource area region which does not overlap a time-frequency resource area in which a corresponding macro cell or a corresponding non-macro cell transmits a PRS, when each of the one or more non-macro cells or each of the one or more macro cells transmits the PRS.

### BRIEF DESCRIPTION OF THE DRAWINGS

FIG. 1 is a view schematically illustrating a wireless communication system, to which exemplary embodiments of the present invention are applied.

FIGS. 2a, 2b and 2c illustrate a structure of a typical subframe and a structure of a typical time slot for data transmission, which may be applied to exemplary embodiments of the present invention.

FIG. 3 illustrates a PRS signal pattern in a communication system considering only a macro cell.

FIG. 4 illustrates a signal transmission scheme for transmitting a PRS.

FIG. 5 illustrates a state of transmitting a PRS in a heterogeneous communication environment, to which the present invention may be applied.

FIG. 6 is a view illustrating a scheme for transmitting a PRS according to a first embodiment of the present invention.

FIG. 7 is a view illustrating a scheme for transmitting a PRS according to a second embodiment of the present invention.

FIG. 8 is a view illustrating a scheme for transmitting a PRS according to a third embodiment of the present invention.

FIG. 9 is a view illustrating a scheme for transmitting a PRS according to a fourth embodiment of the present invention.

FIG. 10 is a flowchart illustrating a method for transmitting a PRS according to an exemplary embodiment of the present invention.

FIG. 11 is a flowchart illustrating a method for receiving a PRS according to an exemplary embodiment of the present invention.

FIG. 12 is a block diagram illustrating functional blocks of an apparatus for allocating a PRS, which generates a PRS sequence and allocates the PRS sequence to a Resource Element (RE), according to an exemplary embodiment of the present invention.

FIG. 13 is a block diagram illustrating functional blocks of a device for transmitting a PRS, to which exemplary embodiments of the present invention are applied.

FIG. 14 is a block diagram illustrating a configuration of a device for receiving a PRS transmitted by using a scheme for allocating and transmitting a PRS, according to an exemplary embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

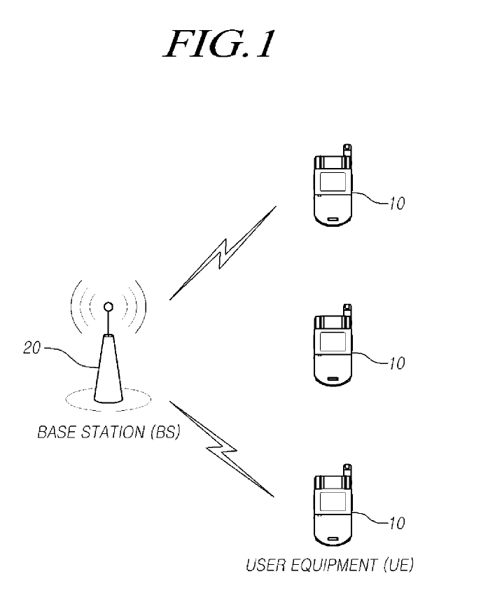

FIG. 1 illustrates a wireless communication system, to which exemplary embodiments of the present invention are applied.

The wireless communication system is widely arranged in order to provide various communication services, such as voice, packet data, and the like.

Referring to FIG. 1, the wireless communication system includes a User Equipment (UE) 10 and a Base Station (BS) 20.

In this specification, the UE 10 has a comprehensive concept implying a user terminal in wireless communication. Accordingly, the UEs should be interpreted as having the concept of including a Mobile Station (MS), a User Terminal (UT), a Subscriber Station (SS), a wireless device, and the like in Global System for Mobile Communications (GSM) as well as User Equipments (UEs) in Wideband Code Division Multiple Access (WCDMA), Long Term Evolution (LTE), High Speed Packet Access (HSPA), and the like.

The BS 20 or a cell usually refers to a station communicating with the UE 10, and may be called different terms, such as a Node-B, an evolved Node-B (eNB), a Base Transceiver System (BTS), an Access Point (AP), a relay node, and a Remote Radio Head (RRH).

Specifically, in this specification, the BS 20 or the cell should be interpreted as having a comprehensive meaning including a partial area covered by a Base Station Controller (BSC) in Code Division Multiple Access (CDMA) or by a Node-B in Wideband Code Division Multiple Access (WCDMA), or including all of an apparatus and hardware/software for controlling the partial area. Accordingly, the BS 20 or the cell may be used as a concept equivalent to a megacell, a macro cell, a microcell, a pico cell, a femto cell, a relay node, and an RRH.

In this specification, the UE 10 and the BS 20, which are two transmission and reception subjects used to implement the art or the technical idea described in this specification, are used as a comprehensive meaning, and are not limited by a particularly designated term or word.

There is no limit to multiple access schemes applied to the wireless communication system. For example, use may be made of various multiple access schemes, such as Code Division Multiple Access (CDMA), Time Division Multiple Access (TDMA), Frequency Division Multiple Access (FDMA), Orthogonal Frequency Division Multiple Access (OFDMA), OFDM (Orthogonal Frequency Division Multiplexing)-FDMA, OFDM-TDMA, and OFDM-CDMA.

In this respect, use may be made of a Time Division Duplex (TDD) scheme in which uplink transmission and downlink transmission are performed at different times. Otherwise, use may be made of a Frequency Division Duplex (FDD) scheme in which uplink transmission and downlink transmission are performed by using different frequencies. Otherwise, use may be made of a Hybrid Division Duplex (HDD) scheme in the form of combining the two schemes.

Exemplary embodiments of the present invention may be applied to the allocation of resources in the field of asynchronous wireless communications which have gone through GSM, WCDMA and HSPA, and evolve into LTE and LTE-advanced, and in the field of synchronous wireless communications which evolve into CDMA, CDMA-2000 and UMB. The present invention should not be interpreted as being limited to or restricted by a particular wireless communication field, but should be interpreted as including all technical fields to which the spirit of the present invention can be applied.

The wireless communication system, to which exemplary embodiments of the present invention are applied, may support an uplink and/or downlink Hybrid Automatic Repeat reQuest (HARQ), and may use a Channel Quality Indicator (CQI) for link adaptation. Also, multiple access schemes for downlink transmission and uplink transmission may be different from each other. For example, Orthogonal Frequency Division Multiple Access (OFDMA) may be used for downlink transmission, and Single Carrier-Frequency Division Multiple Access (SC-FDMA) may be used for uplink transmission.

Layers of a radio interface protocol between a UE and a network may be divided into a first layer (L1), a second layer (L2), and a third layer (L3) based on three lower layers of an Open Systems Interconnection (OSI) model, which is widely known in a communication system. A physical layer belonging to the first layer provides an information transmission service using a physical channel.

Meanwhile, in an example of the wireless communication system, to which exemplary embodiments of the present invention are applied, one wireless frame may include ten subframes, and one subframe may include two slots.

The subframe is a basic unit of data transmission, and downlink or uplink scheduling is performed on a per-subframe basis. One slot may include multiple OFDM symbols in the domain of the time axis and multiple subcarriers in the domain of the frequency axis.

For example, one subframe includes two time slots. In the case of using a normal Cyclic Prefix (CP) in the time domain, each time slot may include seven symbols (six or three symbols in the case of using an extended CP), and may include subcarriers corresponding to a bandwidth of 180 kHz (because it is typical that one subcarrier has a bandwidth of 15 kHz, the bandwidth of 180 kHz corresponds to a total of 12 subcarriers) in the frequency domain. The time-frequency region defined by one slot along the time axis and the bandwidth of 180 kHz along the frequency axis, as described above, may be referred to as a “Resource Block (RB).” However, the time-frequency region according to the present invention is not limited thereto.

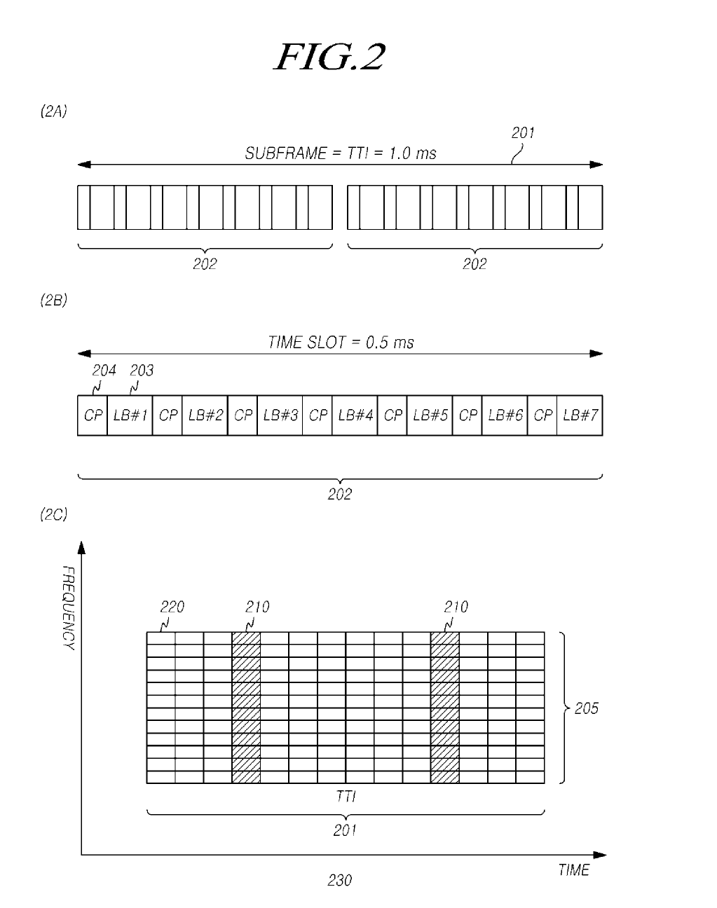

FIG. 2a illustrates a structure of a typical subframe and a structure of a typical time slot for data transmission, which may be applied to exemplary embodiments of the present invention.

Referring to FIG. 2a, the transmission time of a frame is divided into Transmission Time Intervals (TTIs) 201, each having a duration of 1.0 ms. The terms “TTI” and “subframe” may be used in the same meaning. A frame has a length of 10 ms, and includes 10 TTIs.

FIG. 2b illustrates a typical structure of a time slot according to an exemplary embodiment of the present invention.

Referring to FIG. 2b, a TTI is a basic transmission unit, and one TTI includes two equal-length time slots 202, in which each time slot has a duration of 0.5 ms. The time slot includes multiple Long Blocks (LBs) 203, each of which corresponds to a symbol. The LBs 203 are separated from each other by CPs 204. Here, the CPs are classified into a normal CP and an extended CP according to their lengths. When the normal CPs are used, multiple LBs corresponding to seven LBs are included in one time slot. When the extended CPs are used, multiple LBs corresponding to six or three LBs are included in one time slot.

In summary, one TTI or subframe may include 14 LB symbols when the normal CPs are used, or it may typically include 12 LB symbols (or 6 LB symbols in a special case) when the extended CPs are used. However, the present invention is not limited to the structure of the frame, that of the subframe, or that of the time-slot as described above.

FIG. 2c illustrates a configuration of one RB 230 during one subframe or TTI 201 according to an exemplary embodiment of the present invention. Referring to FIG. 2c, each TTI or subframe is divided into 14 symbols (symbol axes) in the case of normal CPs, or divided into 12 (or 6) symbols (symbol axes) 210 in the case of extended CPs, in the time domain. Each symbol (or symbol axis) may carry one OFDM symbol.

Also, an entire system bandwidth of 20 MHz is divided or partitioned into subcarriers 205 having different frequencies. For example, as described above, the region, which includes one slot in the time domain and subcarriers corresponding to the bandwidth of 180 kHz (typically, 12 subcarriers when each subcarrier has a bandwidth of 15 kHz) in the frequency domain, may be referred to as an “RB.”

For example, a bandwidth of 10 MHz within one TTI may include 50 RBs in the frequency domain.

In the RB structure shaped like a grid as described above, each unit space shaped like a grid cell is referred to as a “Resource Element (RE).”

For example, when normal CPs are used and each of the subcarriers has a frequency bandwidth of 15 kHz in a resource region defined by one subframe in the domain of the time axis and a bandwidth of 180 kHz in the domain of the frequency axis, the resource region having the structure as described above may include a total of 168 REs (i.e., 14 symbols×12 subcarriers).

In the LTE communication system, Reference Signals (RSs) defined in downlink include a Cell-specific Reference Signal (CRS), a Multicast/Broadcast over Single Frequency Network Reference Signal (MBSFN-RS), a UE-specific reference signal (or DeModulation Reference Signal (DM-RS), and the like.

Meanwhile, it is necessary to measure a location of a UE in order to provide various location services in Wideband Code Division Multiple Access (WCDMA) and location information required for communication.

In this regard, positioning methods are largely based on three methods, such as 1) a cell coverage-based positioning method, 2) an Observed Time Difference of Arrival (OTDOA) method and 3) a network assisted Global Positioning System (GPS) method. The three methods are complementary to each other rather than competitive with each other, and are appropriately used for different purposes, respectively.

Among the three methods, the OTDOA method is based on measuring a location by measuring relative arrival time of each of RSs (or pilots) from different BSs or cells, and an RS used at this time is a Positioning Reference Signal (PRS).

Because triangulation is used to calculate a location of the UE, the UE must receive relevant RSs from at least three or more different BSs or cells.

In order to facilitate the measurement of a location and avoid near-far problems in the OTDOA method, the WCDMA standard includes Idle Periods in DownLink (IPDL). During the Idle period, the UE must be able to receive an RS from a neighboring cell although an RS, at the same frequency as that of the RS from the neighboring cell, from a cell (i.e., a serving cell) where the UE is currently located is strong.

Also, an LTE system which has evolved from WCDMA of the 3GPP series, is based on OFDM differently from an asynchronous CDMA scheme of WCDMA. Now, a new LTE system considers a scheme for measuring a location based on the OTDOA method as in the case of positioning performed by using the OTDOA method in the WCDMA as described above. To this end, consideration is being given to a scheme for first leaving a data region blank and then transmitting an RS for positioning (i.e., a PRS) through the data region, which is left blank, on a predetermined cycle in a structure of one of an MBSFN subframe and a normal subframe or in a structure of each of both subframes.

Specifically, in order to perform positioning in the LTE corresponding to a new and OFDM-based next-generation communication scheme, positioning is based on the OTDOA method in the existing WCDMA, but reconsideration must be given to a method of transmitting an RS for positioning and the configuration of an RS in a new structure for resource allocation, due to a change in communication bases, such as a multiplexing scheme and an access scheme. Also, a more accurate positioning method is required by the progress of communication systems, such as an increase in the movement speed of a UE, a change in an interference environment between BSs and an increase in the complexity of the communication environment.

Accordingly, the LTE is currently in a state of determining a scheme of Release 9 version, with respect to a method for configuring a PRS and transmitting/receiving the PRS in view of the above situation.

Meanwhile, in view of situations for complementing disadvantages and improving various performances in the LTE corresponding to a new and OFDM-based next-generation communication, one of situations considered in improved communication systems following LTE Release 9 version corresponds to a heterogeneous communication environment in which multiple macro cells exist and each of the particular macro cells includes BSs, such as one or more pico cells and femto cells, having forms different from those of the macro cells. As another example of the heterogeneous communication environment, it is possible to take a communication system which includes multiple macro cells and one or more RRHs existing within each of the particular macro cells in a Coordinated Multi-Point (CoMP).

In the heterogeneous communication environment, when a PRS is defined by an existing scheme considering only a macro cell, the effects of interference between the BSs in different forms, such as a pico cell and the like, can increase the probability of error in receiving a PRS. It is also impossible to expect potential benefits which can be obtained when a PRS is transmitted by each of the BSs in different forms, such as a pico cell and the like.

Accordingly, the present invention is intended to propose a method and a device for transmitting/receiving a PRS, which can minimize the effects of interference between BSs in different forms and thereby can improve accuracy in measuring a location of a UE, in a heterogeneous communication environment where multiple macro cells exist and each of the particular macro cells includes BSs, such as one or more pico cells and the like, having forms different from those of the macro cells.

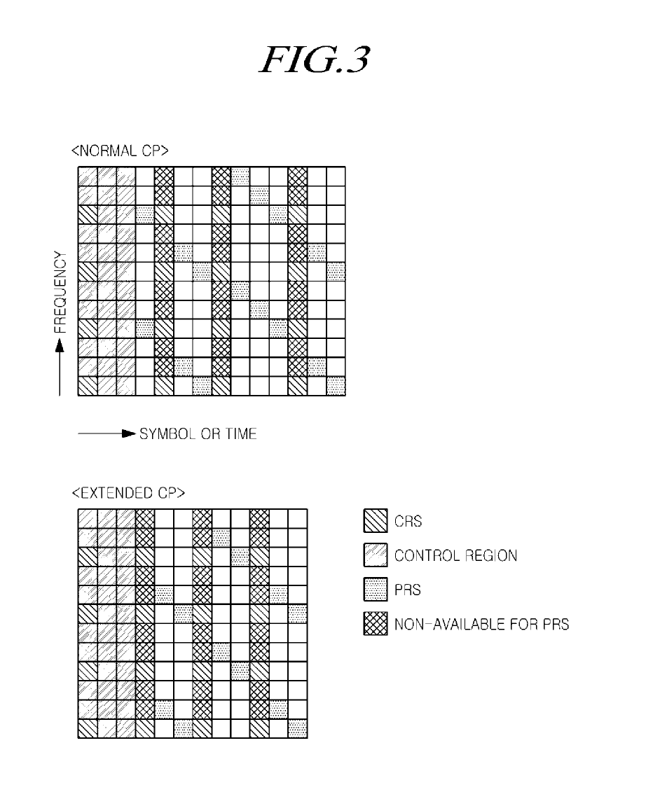

FIG. 3 is a view illustrating a PRS pattern in a communication system considering only a macro cell.

The PRS pattern is defined for one subframe (corresponding to 1 ms) along the time axis and for one RB (which corresponds to a bandwidth of 180 kHz and typically corresponds to 12 subcarriers when one subcarrier has a bandwidth of 15 kHz) along the frequency axis.

Referring to FIG. 3, a PRS is transmitted in a state of leaving blank a data region except for a control region and a CRS in a particular subframe. A pattern for the PRS, namely, an RE allocated a PRS sequence, may be shifted six times along the frequency axis. Accordingly, a PRS is transmitted in different patterns for each of a maximum of six BS (cell) groups. Specifically, each of all BSs (cells) transmits a PRS in one of a total of six patterns during a particular relevant time period. The relevant UE for measuring each PRS receives a PRS that each BS has transmitted during the particular time period as described above, and measures a location thereof.

The frequency shift is based on a BS (cell) number or ID, and only a total of six available patterns exist. However, use is made of a method for reducing interference between neighboring BSs (cells) by appropriately assigning BS (cell) numbers or IDs and adjusting the neighboring BSs (cells) so as to use as different patterns as possible, namely, by performing cell planning.

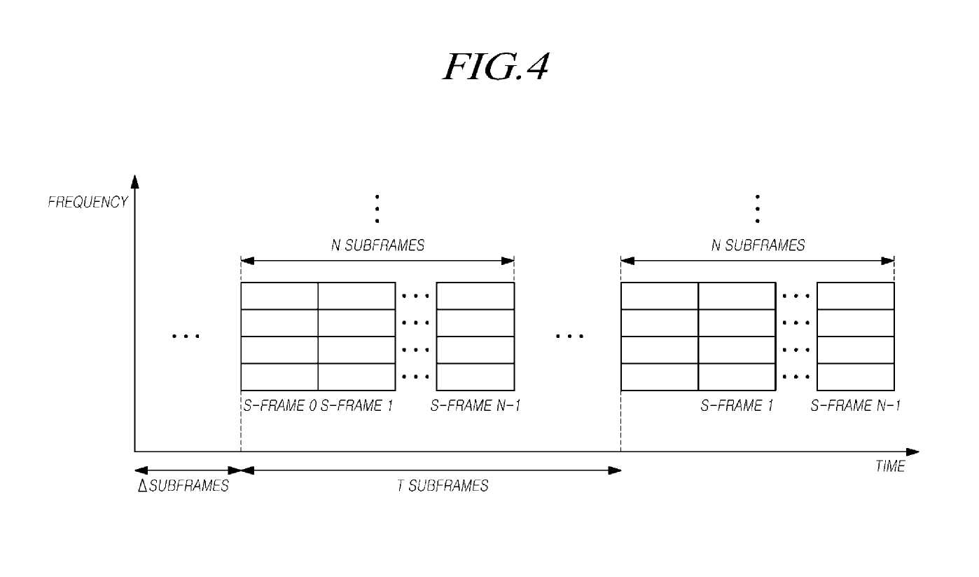

FIG. 4 illustrates a method for transmitting a PRS.

Referring to FIG. 4, a PRS is transmitted in an N number of consecutive subframes having a particular cycle (i.e., T subframes). In FIG. 4, the particular cycle may be one of 160 ms, 320 ms, 640 ms and 1280 ms (because 1 ms corresponds to one subframe, for example, when a cycle has a value of 160 ms, a PRS is transmitted on a 160-subframe cycle). Information on or the value of the particular cycle may be signaled in the form of being combined with a particular offset value by an upper layer.

Accordingly, when the particular cycle is represented by T_{PRS}, the particular offset value is represented by Δ_{PRS}, a value signaled by the upper layer is represented by I_{PRS}, and an N number of consecutive subframes as described above is represented by N_{PRS}, a PRS is transmitted in an N_{PRS} number of subframes which are consecutive from a subframe satisfying Equation (1) below.

(10×n_{f}+└nₛ/2┘−Δ_{PRS})mod T_{PRS}=0 (1)

In Equation (1), T_{PRS} has any one value of 160, 320, 640 and 1280, and Δ_{PRS} has a value of 0 to T_{PRS}−1. Also, I_{PRS} expressed as a value of a total of 12 bits (having a value of 0 to 4095) expresses a case of T_{PRS}=160 and an offset value Δ_{PRS} in this case, when I_{PRS} has a value of 0 to 159. I_{PRS} expresses a case of T_{PRS}=320 and an offset value Δ_{PRS} in this case, when I_{PRS} has a value of 160 to 479. I_{PRS} expresses a case of T_{PRS}=640 and an offset value Δ_{PRS} in this case, when I_{PRS} has a value of 480 to 1119. I_{PRS} expresses a case of T_{PRS}=1280 and an offset value Δ_{PRS} in this case, until I_{PRS} has a value of 1120 to 2399. Also, N_{PRS} represents a value transmitted by an upper layer, and has any one value of 1, 2, 4 and 6. Further, n_{f} represents a system frame number, and nₛ represents a slot number.

For example, when N_{PRS}=4 which is signaled by an upper layer and I_{PRS}=200, a cycle T_{PRS}=320 and an offset Δ_{PRS}=40. Accordingly, an offset is expressed as 40 subframes, and a PRS is transmitted in four consecutive subframes on a 320-subframe cycle.

At this time, all the BSs (cells) do not transmit PRSs, but particular BSs (cells) transmit PRSs in subframes configured to transmit a PRS. Also, some of the remaining BSs is (cells) which do not transmit PRSs, do not transmit PRSs in the subframes configured to cause the particular BSs (cells) to transmit PRSs, but may perform muting or blanking corresponding to transmission with zero power, in the subframes. The muting or blanking is a method for reducing the effects of interference between multiple neighboring BSs (cells) in view of the existence of the multiple neighboring BSs (cells) all having an identical PRS pattern.

Here, the muting may be performed during each transmission cycle T_{PRS} of a PRS. Based on bitmap information in which each transmission cycle T_{PRS} is regarded as one bit and the transmission cycles are 2, 4, 8, or 16 cycles, a determination is made as to whether an N_{PRS} number of subframes configured to transmit a PRS during each transmission cycle are to be used to actually transmit a PRS or to perform muting. The bitmap information is configured for each BS (cell), and is transmitted by an upper layer.

For example, when bitmap information is configured as 4-bit bitmap information in view of 4 cycles and values of the 4 bits is equal to 1001 (here, 1 represents the transmission of a PRS and 0 represents muting, but it goes without saying that bitmap information may be configured in such a manner that 0 represents the transmission of a PRS and 1 represents muting), PRSs are actually transmitted in an N_{PRS} number of subframes configured to transmit PRSs during a first PRS transmission cycle and during a fourth PRS transmission cycle. In contrast, an N_{PRS} number of subframes configured to transmit PRSs during a second PRS transmission cycle and during third PRS transmission cycle are used not to transmit PRSs, but to perform muting corresponding to transmission with zero power.

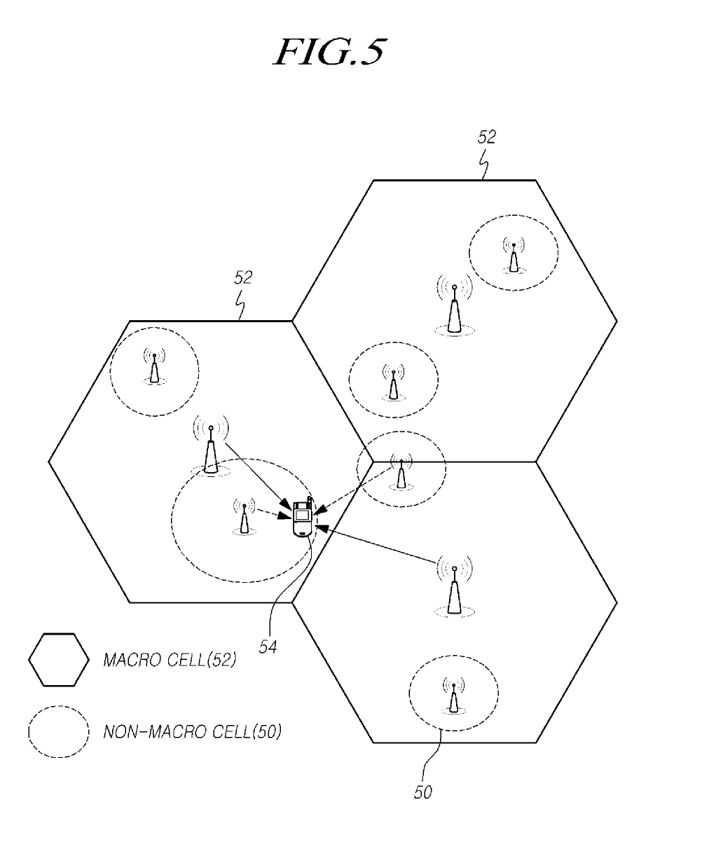

FIG. 5 is a view illustrating a state of transmitting a PRS in a heterogeneous communication environment, to which the present invention may be applied.

Referring to FIG. 5, non-macro cells 50 such as a pico cell and a femto cell may exist within each of macro cells 52. At this time, a UE 54 located within a particular non-macro cell receives signals transmitted by not only the non-macro cell but also the macro cell.

In FIG. 5, the transmission of a signal by the non-macro cell is represented by a dotted line, and the transmission of a signal by the macro cell is represented by a solid line.

In this specification, the term “non-macro cell” typically refers to a pico cell, but the non-macro cell according to the present invention is not limited thereto. The term “non-macro cell” should be interpreted as a comprehensive term signifying all types of non-macro cells, such as a femto cell, a microcell, an RRH and the like, existing within a macro cell which is a BS or cell of a typical communication system, in addition to the pico cell.

Accordingly, as described above, when a PRS is defined considering only a macro cell, the effects of interference between the BSs in different forms, such as a pico cell and the like, can increase the probability of error in receiving a PRS. It is also impossible to expect potential benefits which can be obtained when a PRS is transmitted by each of the BSs in different forms, such as a pico cell and the like.

Also, when a PRS is defined considering only a macro cell, it is possible to implement that a non-macro cell does not transmit a PRS. However, this configuration is disadvantageous in that it is impossible to perform positioning.

Accordingly, an exemplary embodiment of the present invention proposes a method and a device for transmitting/receiving a PRS, which can minimize the effects of interference between BSs in different forms and thereby can improve accuracy in measuring a location of a UE, in a heterogeneous communication environment in which multiple macro cells exist and each of the particular macro cells includes non-macro cells, such as one or more pico cells and the like, having forms different from those of the macro cells.

A scheme for transmitting a PRS according to an exemplary embodiment of the present invention allows one or more macro cells or one or more non-macro cells to form their PRS patterns and to transmit PRSs by using their PRS patterns, in a time-frequency resource area region which does not overlap a time-frequency resource area in which a corresponding macro cell or a corresponding non-macro cell transmits a PRS, when the one or more non-macro cells or the one or more macro cells transmit the PRSs in a heterogeneous communication system having the one or more macro cells and the one or more non-macro cells existing within each of the macro cells.

Here, the term “corresponding macro cell” typically refers to a macro cell including a non-macro cell which transmits a PRS. However, the corresponding macro cell according to the present invention is not limited thereto, and may be another macro cell adjacent to the non-macro cell which transmits a PRS. Also, the term “corresponding non-macro cell” typically refers to a non-macro cell included in a macro cell which transmits a PRS. However, the corresponding non-macro cell according to the present invention is not limited thereto, and may be a non-macro cell included in another macro cell adjacent to the macro cell which transmits a PRS.

In a first embodiment of the present invention, when a non-macro cell transmits a PRS thereof, a PRS transmission parameter of a non-macro cell may be used after it is defined separately from PRS transmission parameters (i.e., a transmission cycle T_{M}, a PRS transmission offset Δ_{M}, the number N_{M} of PRS transmission subframes, and the like) of the corresponding macro cell (i.e., a macro cell including the non-macro cell which transmits a PRS, or another macro cell adjacent to the non-macro cell which transmits a PRS). Specifically, a PRS transmission cycle T_{P}, a PRS transmission offset Δ_{P} and the number N_{P} of PRS transmission subframes of a pico cell, which is the non-macro cell, are defined separately from a PRS transmission cycle T_{M}, a PRS transmission offset Δ_{M} and the number N_{M} of PRS transmission subframes of a macro cell, and a PRS of the non-macro cell may be transmitted in an N_{P} number of consecutive subframes by using the PRS transmission cycle T_{P} and the PRS transmission offset Δ_{P} which are separate from the macro cell.

In a second embodiment of the present invention, when a non-macro cell transmits a PRS thereof, it is possible to transmit a PRS of the non-macro cell only in one or more of subframes, in which a macro cell does not transmit a PRS, within the range of a PRS transmission subframe of the corresponding macro cell (i.e., a macro cell including the non-macro cell which transmits a PRS, or another macro cell adjacent to the non-macro cell which transmits a PRS).

In a third embodiment of the present invention, when a non-macro cell transmits a PRS thereof, by using a PRS transmission cycle of a macro cell and a PRS transmission offset thereof, and in a PRS transmission subframe thereof, the macro cell and the non-macro cell may divide an N number of consecutive transmission subframes, and may transmit a PRS of the macro cell and that of the non-macro cell in the divided consecutive transmission subframes, respectively.

In the first to third embodiments of the present invention as described above, the transmission of a PRS by the non-macro cell is distinguished from the transmission of a PRS by the macro cell according to Time Division Multiplexing (TDM), namely, a TDM scheme. In contrast, in the fourth embodiment of the present invention, when a non-macro cell transmits a PRS thereof, by using a PRS transmission cycle of a relevant macro cell and a PRS transmission offset thereof, and in a PRS transmission subframe thereof, the relevant macro cell and the non-macro cell may divide a transmission frequency band, and may transmit a PRS of the relevant macro cell and that of the non-macro cell in the divided transmission frequency bands, respectively. A frequency band may be divided in a unit of RB. However, the present invention is not limited to the first to fourth embodiments thereof.

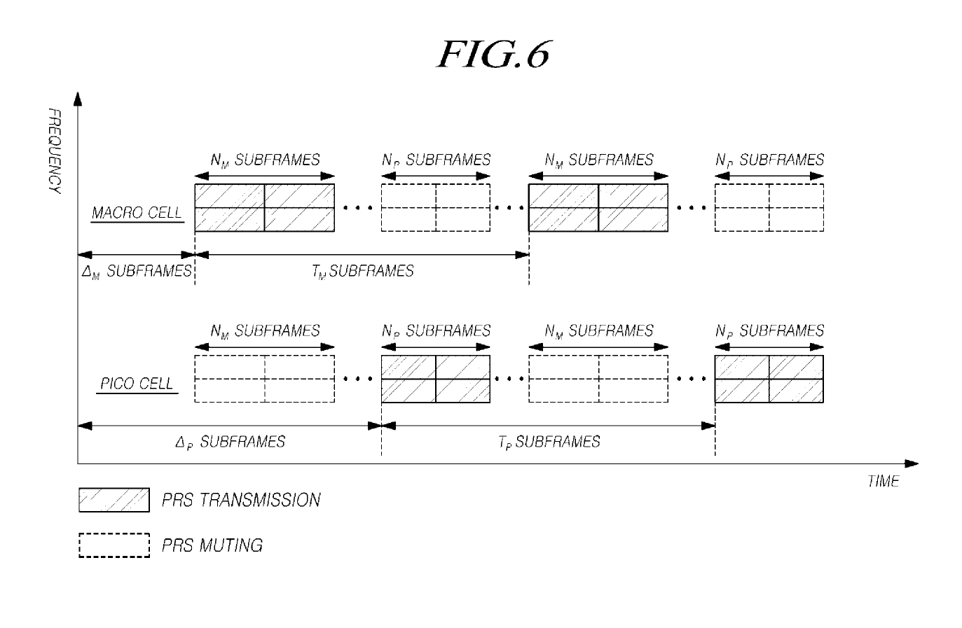

Hereinafter, detailed configurations of the first to fourth embodiments of the present invention will be described in detail with reference to FIG. 6 to FIG. 9.

In the following description, a pico cell will be described as an example of a non-macro cell. As described above, the term “non-macro cell” should be interpreted as a comprehensive term signifying all types of non-macro cells existing within a macro cell which is a BS or cell of a typical communication system.

Here, in the first to fourth embodiments of the present invention as illustrated in FIG. 6 to FIG. 9, each macro cell allocates PRS patterns by using macro cell planning that each macro cell performs in such a manner that neighboring macro cells basically have different PRS patterns among six PRS patterns. Separately from the macro cells, each pico cell allocates PRS patterns by using pico cell planning that each pico cell performs in such a manner that neighboring pico cells basically have different PRS patterns among the six PRS patterns.

At this time, particularly, each of pico cells falling within each macro cell may perform the pico cell planning in such a manner that the pico cells have as different PRS patterns as possible.

Specifically, in allocating PRS patterns by performing the cell planning on the six PRS, each of macro cells or pico cells allocates different PRS patterns to neighboring macro cells or pico cells in such a manner that the PRS patterns do not overlap between the neighboring macro cells or pico cells.

### First Embodiment

### A Method in which a Pico Cell Transmits a PRS According to Parameters Separate from a Macro Cell

FIG. 6 is a view illustrating a scheme for transmitting a PRS according to a first embodiment of the present invention.

In the first embodiment of the present invention, PRS transmission parameters of a pico cell, such as a PRS transmission cycle T_{P}, a PRS transmission offset Δ_{P} and the number N_{P} of PRS transmission subframes, are defined separately from PRS transmission parameters of a macro cell, such as a PRS transmission cycle T_{M}, a PRS transmission offset Δ_{M} and the number N_{M} of PRS transmission subframes. This definition may minimize the flexibility of the PRS transmission cycle T_{P}, the PRS transmission offset Δ_{P} and the number N_{P} of PRS transmission subframes of the pico cell.

Also, the macro cell may transmit a PRS thereof in an N_{M} number of consecutive subframe according to the relevant PRS transmission cycle T_{M} and the relevant PRS transmission offset Δ_{M}, in the scheme of the related art. According to upper layer bitmap information in which each cycle is regarded as one bit, the macro cell may transmit a PRS thereof during each cycle, or may not transmit the PRS thereof but may perform muting during each cycle.

The pico cell may transmit a PRS in an N_{P} number of consecutive subframes, is according to the PRS transmission cycle T_{P} and the PRS transmission offset Δ_{P} which are defined separately from those of the macro cell. As in the case of the macro cell, according to the upper layer bitmap information in which each cycle is regarded as one bit, the pico cell may transmit a PRS thereof during each cycle, or may not transmit the PRS thereof but may perform muting during each cycle.

In the first embodiment of the present invention, the pico cell defines PRS transmission parameters independently of a particular macro cell together with performing the appropriate cell planning. As a result, the pico cell allows the transmission of a PRS thereby to be distinguished from the transmission of a PRS by the particular macro cell. However, in order to prevent overlap between a PRS transmission frame of the pico cell and that of the particular macro cell, by using muting information (e.g., upper layer bitmap information) which allows the transmission of a PRS during each PRS transmission cycle or allows performing of muting without transmission of the PRS during each PRS transmission cycle, it is possible to prevent the overlap between a PRS transmission frame of the pico cell and that of the particular macro cell. Specifically, by using appropriate muting information, the pico cell may not transmit a PRS thereof in subframes in which the particular macro cell transmits a PRS thereof.

However, in the first embodiment of the present invention, it is sufficient to define PRS transmission parameters of the pico cell independently of those of the particular macro cell. In order to prevent the overlap between a PRS transmission frame of the pico cell and that of the particular macro cell, other technologies may be used, as well as the use of the muting information.

In the first embodiment of the present invention, subframes in which the macro cell transmits a PRS thereof may be distinguished from subframes in which the pico cell transmits a PRS thereof, in order to prevent overlap therebetween. Specifically, this description implies that a time-frequency region in which the macro cell transmits a PRS is distinguished in time from a time-frequency region in which the pico cell transmits a PRS.

Also, when the macro cell transmits a PRS thereof, a time-frequency resource region of the pico cell which is matched to the relevant PRS transmission time-frequency resource region, may be muted. In contrast, when the pico cell transmits a PRS thereof, a time-frequency resource region of the macro cell which is matched to the relevant PRS transmission time-frequency resource region, may be muted. However, the present invention is not limited to this configuration.

Also in this case, when the macro cell (or the pico cell) does not actually transmit a PRS thereof but performs muting in subframes, which are configured to cause the macro cell (or the pico cell) to transmit a PRS thereof, according to the upper layer bitmap information, the pico cell (or the macro cell) may not need to perform separate muting in a time-frequency resource region included in a muted PRS transmission cycle. Specifically, it is sufficient to mute (muting implies that data and the like are not transmitted or transmission with zero power is performed) only a time-frequency resource region of the corresponding pico cell (or the macro cell) with respect to only a part at which the macro cell (or the pico cell) actually transmits a PRS thereof.

In the first embodiment of the present invention, PRS transmission parameters of the pico cell may be defined completely independently of those of the relevant macro cell. In contrast, the PRS transmission parameters of the pico cell may have certain relations with those of the relevant macro cell.

For example, for ease of system configuration and for the convenience of channel measurement, when a definition is made of the PRS transmission cycle T_{P}, the PRS transmission offset Δ_{P} and the number N_{P} of PRS transmission subframes of the pico cell, the PRS transmission cycle T_{P} of the pico cell may have a value equal to that of the PRS transmission cycle T_{M} of the macro cell (T_{P}=T_{M}), and the PRS transmission offset Δ_{P} of the pico cell may be defined as the sum (Δ_{P}=Δ_{M}+N_{M}) of the PRS transmission offset Δ_{M} of the macro cell and the number N_{M} of PRS transmission subframes of the macro cell. In this case, subframes in which the pico cell transmits a PRS thereof may successively follow subframes in which the macro cell transmits a PRS thereof. Otherwise, the PRS transmission cycle T_{P} of the pico cell may have a value equal to that of the PRS transmission T_{M} cycle of the macro cell (T_{P}=T_{M}), and the PRS transmission offset Δ_{P} of the pico cell may be defined by an equation (Δ_{P}=Δ_{M}+10) expressed as adding 10 ms corresponding to one radio frame to the PRS transmission is offset Δ_{M} of the macro cell. In addition, the number N_{M} of PRS transmission subframes of the macro cell may have a value equal to that of the number N_{P} of PRS transmission subframes of the pico cell. In this case, the PRS transmission cycle of the macro cell may be equal to the PRS transmission cycle of the pico cell, and the number of subframes in which the macro cell transmits a PRS thereof may be equal to the number of subframes in which the pico cell transmits a PRS thereof. Here, the pico cell may transmit a PRS thereof in a radio frame which follows a radio frame in which the macro cell transmits a PRS thereof. In this situation, the PRS transmission cycle T_{P}, the PRS transmission offset Δ_{P} and the number N_{P} of PRS transmission subframes of the pico cell may be implicitly known from the PRS transmission cycle T_{M}, the PRS transmission offset Δ_{M} and the number of PRS transmission subframes N_{M} of the macro cell. Accordingly, signaling may not be separately required.

### Second Embodiment

### A Method in which a Pico Cell Transmits a PRS within a PRS Transmission Range of a Macro Cell

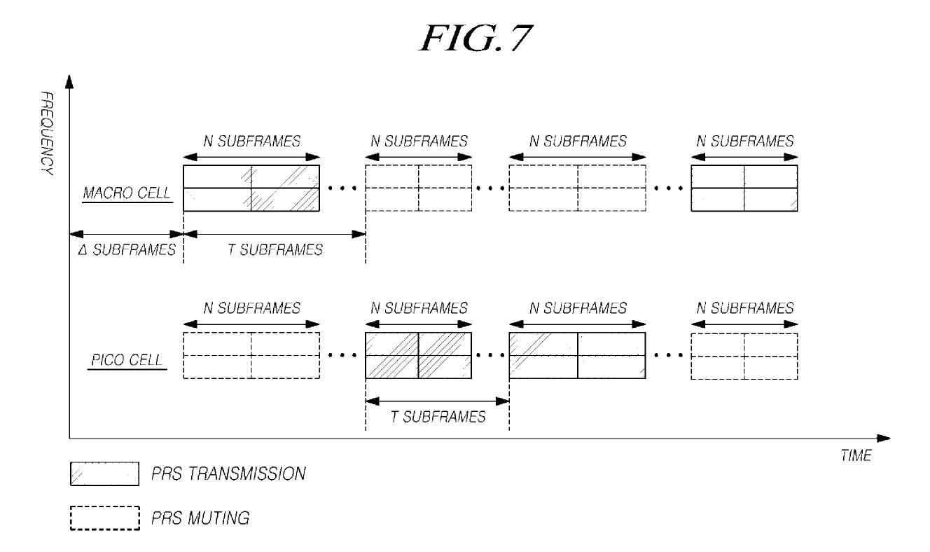

FIG. 7 is a view illustrating a scheme for transmitting a PRS according to a second embodiment of the present invention.

In the second embodiment of the present invention as illustrated in FIG. 7, a pico cell may transmit a PRS thereof only in a part or whole of a time-frequency resource area in which a particular macro cell does not transmit a PRS thereof but performs muting, within PRS transmission subframes configured to transmit a PRS of the particular macro cell (a macro cell including the pico cell, another macro cell adjacent to the macro cell including the pico cell, or the like).

Specifically, the macro cell may transmit a PRS in an N number of consecutive subframe according to a relevant PRS transmission cycle T and a relevant PRS transmission offset Δ, in the scheme of the related art. As described above, according to the upper layer bitmap information in which each cycle is regarded as one bit, the macro cell may transmit a PRS during each cycle, or may not transmit the PRS but may perform muting during each cycle.

In this case, the pico cell transmits a PRS in some or all of subframes existing within a relevant cycle during which the particular macro cell does not transmit a PRS but performs muting, according to the upper layer bitmap information in which each cycle is regarded as one bit, with respect to subframes during each cycle which are configured to transmit a PRS by the particular macro cell.

For example, when bitmap information that an upper layer has transmitted in order to cause the macro cell to transmit a PRS is equal to 1001 (here, 1 represents transmission and 0 represents muting, but it goes without saying that 1 may represent muting and 0 may represent transmission), with respect to four cycles, the macro cell transmits PRSs during a first cycle and a fourth cycle, and does not transmit PRSs but performs muting during a second cycle and a third cycle. Accordingly, the pico cell may transmit PRSs during the second cycle and the third cycle during which the macro cell does not transmit PRSs.

In this case, a PRS transmission cycle, a PRS transmission offset and the number of PRS transmission subframes of the pico cell have values equal to those of PRS transmission parameters of the macro cell. However, only bitmap information for PRS transmission that the upper layer transmits, has a value (i.e., a complement) opposite to that of bitmap information of the macro cell. Specifically, as described above, when the macro cell has a bitmap value of 1001, the pico cell may have a bitmap value of 0110.

Otherwise, when the pico cell does not transmit a PRS during an entire cycle during which the macro cell does not transmit a PRS but performs muting, but transmits the PRS during a part of the entire cycle, bitmap information, which is transmitted to the pico cell, on a cycle during which a PRS is actually transmitted not only may has a value (i.e., a complement) opposite to that of bitmap information of the macro cell on a cycle during which a PRS is actually transmitted, but also may be separately configured with reference to the bitmap information on a cycle on which a PRS of the macro cell is transmitted.

According to the second embodiment of the present invention as illustrated in FIG. 7, subframes in which the macro cell transmits a PRS are automatically distinguished from subframes in which the pico cell transmits a PRS. Specifically, a time-frequency region in which the macro cell transmits a PRS is distinguished in time from a time-frequency region in which the pico cell transmits a PRS. Accordingly, when the macro cell transmits a PRS, a time-frequency resource region of the pico cell which is matched to the relevant PRS transmission time-frequency resources, is also automatically muted. In contrast, when the pico cell transmits a PRS, a time-frequency resource region of the macro cell (i.e., a macro cell including the relevant pico cell, another macro cell adjacent to the macro cell including the relevant pico cell, or the like) which is matched to the relevant PRS transmission time-frequency resources, is also automatically muted.

The second embodiment of the present invention is advantageous in that it is possible to make the best of a configuration for transmitting a PRS by the macro cell which has been defined in the Rel-9 LTE.

### Third Embodiment

### A Method in which a Pico Cell Divides PRS Transmission Subframes of a Macro Cell and Uses the Divided PRS Transmission Subframes

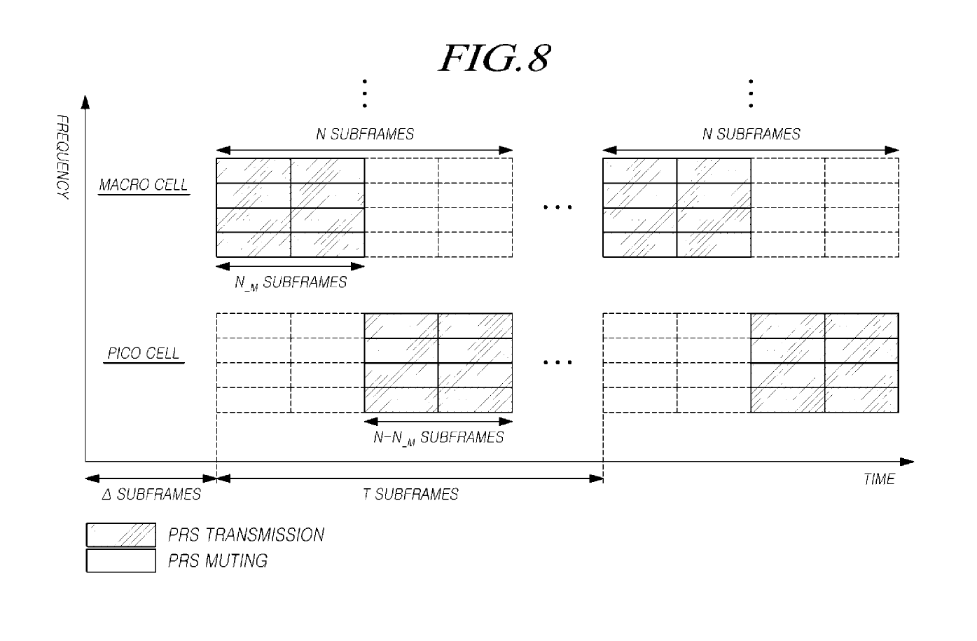

FIG. 8 is a view illustrating a scheme for transmitting a PRS according to a third embodiment of the present invention.

In the third embodiment of the present invention as illustrated in FIG. 8, as expressed in Equation (1), by using a PRS transmission cycle of a macro cell and a PRS transmission offset thereof, and in a PRS transmission subframe thereof, a pico cell and a particular macro cell (i.e., a macro cell including the relevant pico cell, another macro cell adjacent to the macro cell including the relevant pico cell, or the like) may divide an N number of consecutive PRS transmission subframes defined for a macro cell, and may use the divided consecutive transmission subframes.

For example, when an N_{—}_{^{M}} number of subframes are configured to transmit a PRS by the particular macro cell within an N number of consecutive PRS transmission subframes as expressed in Equation (1), an (N−N_{—}_{^{M}}) number of remaining subframes except for an N_{—}_{^{M}} number of subframes are configured to transmit a PRS by the relevant pico cell. Then, each of the particular macro cell and the pico cell transmits a PRS thereof in a relevant PRS transmission frame.

In other words, in the third embodiment of the present invention as illustrated in FIG. 8, the transmission of a PRS is defined by an N number of consecutive subframes according to a relevant PRS transmission cycle T and a relevant PRS transmission offset Δ, in the existing LTE Rel-9 scheme. The relevant macro cell and the relevant pico cell divide the N number of subframes as described above, and use the divided subframes to transmit PRSs.

Also in the third embodiment of the present invention, as described above, according to upper layer bitmap information in which each cycle is regarded as one bit, a PRS may be transmitted during each cycle, or use may be made of a scheme for performing muting without transmitting the PRS during each cycle.

Accordingly, in the third embodiment of the present invention, subframes in which the macro cell transmits a PRS thereof are distinguished in time from subframes in which the pico cell transmits a PRS thereof. Specifically, a time-frequency region in which the macro cell transmits a PRS is distinguished in time from a time-frequency region in which the pico cell transmits a PRS.

Accordingly, also in the third embodiment of the present invention, when the macro cell transmits a PRS thereof, a time-frequency resource region of the relevant pico cell which is matched to the relevant PRS transmission time-frequency resources, is muted. In contrast, when the pico cell transmits a PRS thereof, a time-frequency resource region of the macro cell which is matched to the relevant PRS transmission time-frequency resources, is muted.

Meanwhile, in the third embodiment of the present invention, when the macro cell (or the relevant pico cell) does not actually transmit a PRS thereof in subframes, which are configured to cause the macro cell (or the relevant pico cell) to transmit a PRS thereof, according to the upper layer bitmap information, the pico cell (or the relevant macro cell) does not need to perform muting in a corresponding time-frequency resource region. Specifically, it is sufficient to perform muting without transmitting data and the like in a time-frequency resource region of the corresponding pico cell (or the relevant macro cell) with respect to only a part at which the macro cell (the relevant pico cell) actually transmits a PRS thereof.

### Fourth Embodiment

### A Method in which a Pico Cell Transmits a PRS while Distinguishing a PRS Transmission Frequency Band (RB) of a Macro Cell

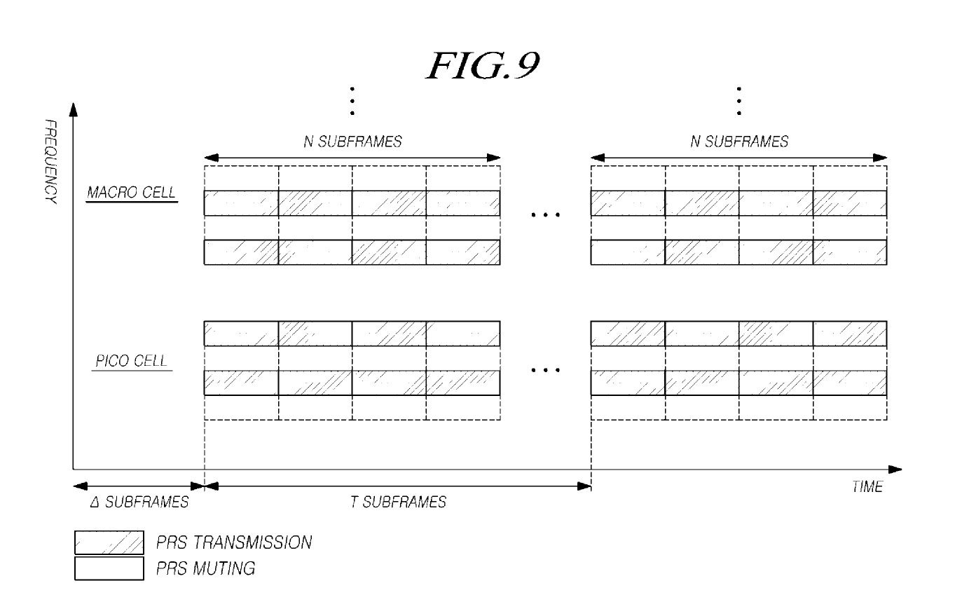

In the fourth embodiment of the present invention as illustrated in FIG. 9, by using a PRS transmission cycle of a macro cell and a PRS transmission offset thereof, and in a PRS transmission subframe thereof, the macro cell and a relevant pico cell divide a PRS transmission frequency band, and use the divided PRS transmission frequency bands.

For example, when even-numbered RBs along the frequency axis are configured to cause the macro cell to transmit a PRS, the remaining odd-numbered RBs except for the even-numbered RBs along the frequency axis are configured to cause the relevant pico cell to transmit a PRS.

In other words, in the fourth embodiment of the present invention, the transmission of a PRS is defined by an N number of consecutive subframes according to a PRS transmission cycle T and a PRS transmission offset Δ. Although the macro cell and the relevant pico cell may transmit their respective PRSs in identical PRS transmission subframes, they transmit their respective PRSs in such a manner that the transmission of a PRS by the macro cell is distinguished from the transmission of a PRS by the relevant pico cell along the frequency axis.

As in the previous embodiments of the present invention, according to the upper layer bitmap information in which each cycle is regarded as one bit, each of the macro cell and the pico cell may transmit a PRS thereof during each cycle, or may not transmit the PRS thereof but may perform muting during each cycle.

According to the fourth embodiment of the present invention as described above, an RB in which the macro cell transmits a PRS is distinguished from an RB in which the relevant pico cell transmits a PRS. More specifically, according to a Frequency Division Multiplexing (FDM) scheme, a time-frequency region in which the macro cell transmits a PRS is distinguished from a time-frequency region in which the relevant pico cell transmits a PRS.

Accordingly, when the macro cell transmits a PRS, a time-frequency resource region of the pico cell which is matched to the relevant PRS transmission time-frequency resources, is muted. In contrast, when the pico cell transmits a PRS, a time-frequency resource region of the macro cell which is matched to the relevant PRS transmission time-frequency resources, is muted.

Meanwhile, in the fourth embodiment of the present invention, when the macro cell (or the corresponding pico cell) does not actually transmit a PRS thereof in subframes, which are configured to cause the macro cell (or the corresponding pico cell) to transmit a PRS thereof, according to the upper layer bitmap information, the corresponding pico cell (or the macro cell) does not need to perform muting in a corresponding time-frequency resource region. Specifically, it is sufficient to perform muting without transmitting data and the like in a time-frequency resource region of the corresponding pico cell (or the macro cell) with respect to only a part at which the macro cell (or the corresponding pico cell) actually transmits a PRS thereof.

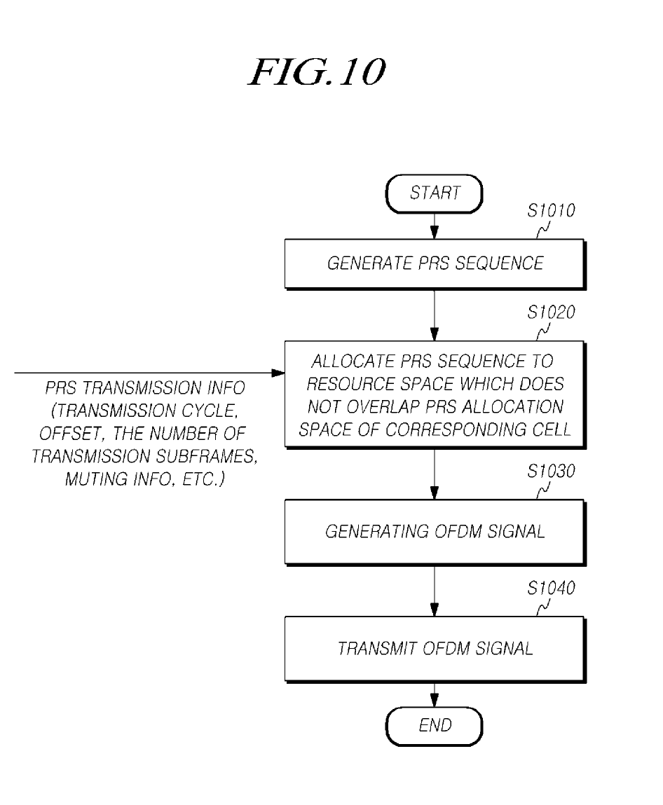

FIG. 10 is a flowchart illustrating a method for transmitting a PRS according to an exemplary embodiment of the present invention.

The method for transmitting a PRS in a communication system where there exist one or more macro cells or one or more pico cells included in the one or more macro cells, according to an exemplary embodiment of the present invention, may include: step S1010 of generating a cell-specific PRS sequence by the macro cell or the pico cell; step S1020 of allocating or mapping the generated PRS sequence to a time-frequency resource area by using PRS transmission information, wherein the macro cell or the pico cell allocates or maps the generated PRS sequence to the time-frequency resource area which does not overlap a PRS allocation resource area of the corresponding pico cell or the corresponding macro cell; step S1030 of generating an OFDM signal including the allocated or mapped PRS sequence; and step S1040 of transmitting the generated OFDM signal.

Here, in a heterogeneous communication environment in which multiple macro cells exist and each of the particular macro cells includes non-macro cells (or non-macro BSs), such as one or more pico cells and the like, having forms different from those of the macro cells, the term “corresponding macro cell” may refer to a macro cell including a pico cell which transmits a PRS, or another macro cell adjacent to the pico cell which transmits a PRS. The term “corresponding pico cell” may refer to a pico cell included in a macro cell which transmits a PRS, or a pico cell included in another macro cell adjacent to the macro cell which transmits a PRS, in the heterogeneous communication environment. However, the corresponding macro cell and the corresponding pico cell according to the present invention are not limited thereto, and should be interpreted as including all of one or more macro cells and pico cells, from which the UE may use PRSs.

Also, The PRS transmission information used to allocate or map the PRS sequence to a time-frequency resource area in step S1020 may include a PRS pattern, the number of PRS transmission subframes, a PRS transmission cycle, a PRS transmission offset, PRS muting information, and the like. However, the PRS transmission information according to the present invention is not limited thereto. The PRS transmission information may be transmitted from the upper layer to each BS through Radio Resource Control (RRC). However, the PRS transmission information according to the present invention is not limited thereto.

The step of allocating or mapping the PRS sequence to a time-frequency resource area may be performed while being interlocked with mapping other pieces of information (data, a control signal, or the like) to REs, or may be performed while being included in the RE mapping. Specifically, this step may correspond to a step of selecting or allocating (this selection or allocation corresponds to a PRS pattern) REs for a PRS sequence from among all REs, which become targets of RE mapping, and mapping the previously-generated PRS sequence to the selected REs.

Also, in step S1020, in order to cause the macro cell or the pico cell to allocate or map the generated PRS sequence to the time-frequency resource area which does not overlap a PRS allocation resource area of the corresponding pico cell or the corresponding macro cell, the configurations according to the first to fourth embodiments of the present invention as described above may be used.

Specifically, largely, there are a TDM scheme in which a PRS allocation resource area of the pico cell is distinguished in time from that of the corresponding macro cell, and an FDM scheme in which a PRS allocation resource area of the pico cell is distinguished in frequency from that of the corresponding macro cell. The TDM scheme may again include: 1) the first embodiment (shown in FIG. 6), in which the PRS transmission parameters of the pico cell are defined independently of those of the corresponding macro cell and then are used; 2) the second embodiment (shown in FIG. 7), in which the pico cell allocates (or maps) a PRS sequence thereof to only subframes in which the corresponding macro cell does not actually transmit a PRS within the range of PRS transmission subframes of the corresponding macro cell; and 3) the third embodiment, in which the pico cell divides, in time, PRS transmission subframes defined in the corresponding macro cell according to the scheme of the related art and uses the divided PRS transmission subframes. However, the TDM scheme according to the present invention is not limited thereto.

Also, the FDM scheme may include the fourth embodiment, in which the pico cell divides a frequency band in a unit of RB with respect to PRS transmission subframes defined in the corresponding macro cell, according to the scheme of the related art, and allocates or maps a PRS sequence thereof so as to prevent overlap between a PRS pattern thereof and that of the corresponding macro cell. However, the FDM scheme according to the present invention is not limited thereto.

More specifically, when the pico cell transmits a PRS thereof, the TDM scheme may include the first embodiment, in which the pico cell uses PRS transmission information thereof after the pico cell defines the PRS transmission information thereof separately from the PRS transmission information (the PRS transmission cycle T_{M}, the PRS transmission offset Δ_{M}, the number N_{M} of PRS transmission subframes, and the like) of the corresponding macro cell.

Also, the TDM scheme may use the second embodiment, in which the corresponding pico cell or the corresponding macro cell allocates or maps a PRS sequence to a part or whole of a time-frequency resource area in which the corresponding pico cell or the corresponding macro cell does not transmit a PRS but performs muting, in PRS transmission subframes configured to cause the corresponding pico cell or the corresponding macro cell to transmit a PRS.

Also, the TDM scheme may use a configuration of the third embodiment, in which the pico cell and the macro cell divide an N number of consecutive PRS transmission subframes configured to cause the corresponding macro cell and the corresponding pico cell to transmit their respective PRSs, and allocate or map the PRS sequences to the divided consecutive PRS transmission subframes.

Meanwhile, the FDM scheme may use the fourth embodiment, in which the pico cell or the macro cell allocates or maps a PRS sequence to a frequency band (which may be divided in a unit of one or more RBs) other than a frequency band which is allocated the PRS sequence of the corresponding macro cell or the corresponding pico cell, within a time-frequency resource area configured to cause the corresponding macro cell or the corresponding pico cell to transmit a PRS.

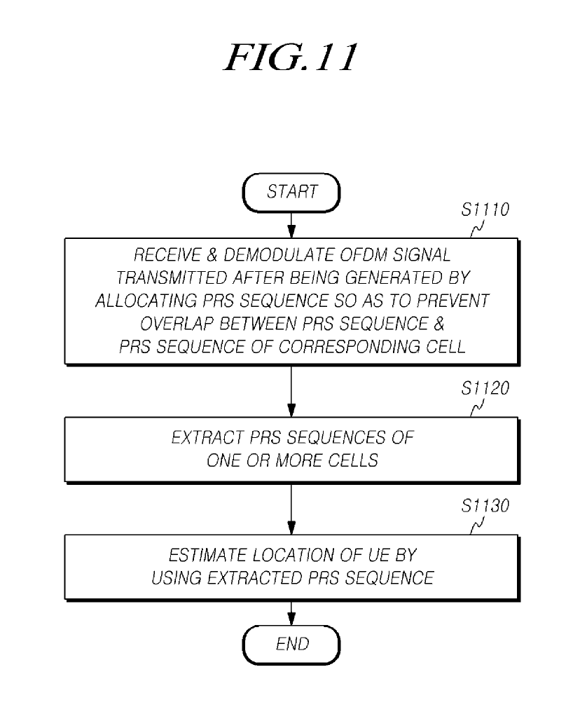

FIG. 11 is a flowchart illustrating a method for receiving a PRS according to an exemplary embodiment of the present invention.

The method for receiving a PRS according to an exemplary embodiment of the present invention is typically performed by a UE. However, the method according to the present invention is not limited thereto.

The method for receiving a PRS according to an exemplary embodiment of the present invention may include: a step S1110 of receiving and demodulating an OFDM signal transmitted while including PRS sequences allocated (or mapped) to a resource area so as to prevent overlap between the PRS sequences of one or more pico cells and one or more macro cells matched to each pico cell; a step S1120 of extracting PRS sequences of one or more cells among the one or more macro cells and the one or more pico cells from the demodulated OFDM signal; and a step S1130 of estimating location information of a UE by using the extracted PRS sequence.

In step S1110, the OFDM signal that the UE receives, is a signal generated by using OFDM modulation after the PRS sequence of the pico cell and that of the corresponding macro cell are allocated (or mapped) to a time-frequency resource area so as to prevent overlap between the PRS sequence of the pico cell and that of the corresponding macro cell.

The schemes as described above with reference to FIG. 6 to FIG. 9 may be used to generate an OFDM signal after a PRS sequence is allocated (or mapped) to a time-frequency resource area in such a manner to prevent overlap between a resource area allocated the PRS sequence of the macro cell (or the pico cell) and a resource area allocated the PRS sequence of the corresponding pico cell (or the corresponding macro cell).

Specifically, the schemes as described above with reference to FIG. 6 to FIG. 9 may include: 1) the first embodiment, in which the PRS transmission parameters of the pico cell are defined independently of those of the corresponding macro cell and then are used; 2) the second embodiment, in which the pico cell allocates (or maps) a PRS sequence thereof to only subframes in which the corresponding macro cell does not actually transmit a PRS within the range of PRS transmission subframes of the corresponding macro cell; 3) the third embodiment, in which the pico cell divides, in time, PRS transmission subframes defined in the corresponding macro cell according to the scheme of the related art and uses the divided PRS transmission subframes; and 4) the fourth embodiment, in which the pico cell divides a frequency band in a unit of RB with respect to PRS transmission subframes defined in the corresponding macro cell, according to the scheme of the related art, and allocates or maps a PRS sequence thereof so as to prevent overlap between a PRS pattern thereof and that of the corresponding macro cell. However, the present invention is not limited to this configuration. In order to avoid redundancy of description, a detailed description thereof will be omitted.

The extraction of a PRS sequence in step S1120 may be performed while being interlocked with RE demapping which extracts particular information (data, a control signal, or the like) from the demodulated OFDM signal, or may be performed while being included in the RE demapping. Specifically, the extraction of a PRS sequence in step S1120 may be performed as a step of selecting (this selection corresponds to a PRS pattern) only REs for a PRS of the pico cell or the macro cell from among all REs, which become targets of RE demapping in an RE demapping process after demodulating an OFDM signal, and extracting a PRS sequence mapped to the selected REs.

The estimation of location information in step S1130 may be performed as a step of extracting a PRS sequence of each cell from an OFDM signal transmitted by each cell (desirably, three or more pico cells or macro cells), measuring a peak value of autocorrelation through performing the autocorrelation on the extracted PRS sequence and then measuring a delay time of the OFDM signal transmitted by each cell, and thereby estimating location information of the UE according to triangulation.

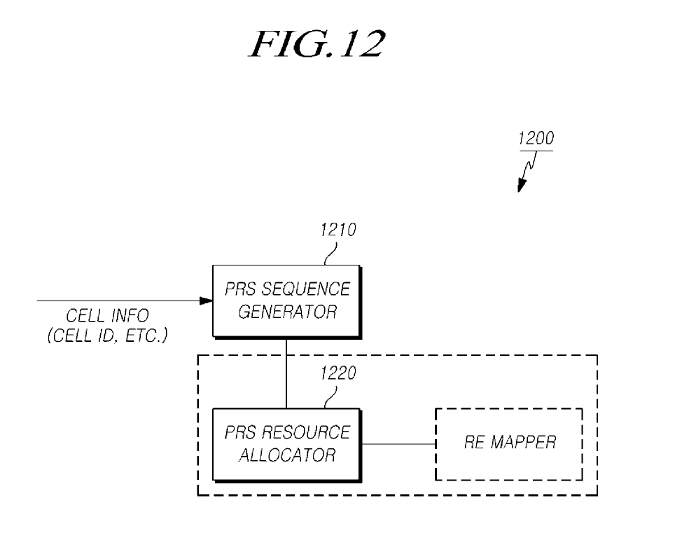

FIG. 12 is a block diagram illustrating functional blocks of an apparatus for allocating a PRS, which generates a PRS sequence and allocates the PRS sequence to an RE, according to an exemplary embodiment of the present invention.

Referring to FIG. 12, the apparatus 1200 for allocating a PRS according to an exemplary embodiment of the present invention includes a PRS sequence generator 1210 and a PRS resource allocator 1220.

The PRS sequence generator 1210 receives, as input, external information such as system-specific information and the like, and generates a cell-specific PRS sequence based on the received external information. Here, the system-specific information may be one or more of BS information (a cell ID and the like), relay node information, UE information, a subframe number, a slot number, an OFDM symbol number, and CP sizes. However, the system-specific information according to the present invention is not limited thereto. Meanwhile, the BS (cell) information, for example, may be BS antenna information, BS bandwidth information, and BS cell ID information.

For example, the PRS sequence generator 1210 may receive, as input, information such as a cell ID, a slot number, an OFDM symbol number and a CP size, and may generate a PRS sequence of each relevant cell.

The PRS resource allocator 1220 allocates the PRS sequence, that the PRS sequence generator 1210 has generated, to a time-frequency resource region. Then, the PRS sequence allocated to REs is multiplexed with a BS transmission frame.

The PRS resource allocator 1220 allocates resources at a relevant position on the time (OFDM symbol) axis and a relevant position on the frequency (subcarrier) axis by predetermined rules in a method of allocating resources for PRSs, and performs a basic function of multiplexing the allocated resources with a BS transmission frame at a predetermined frame timing.

Meanwhile, the PRS resource allocator 1220 according to an exemplary embodiment of the present invention allocates or maps the generated PRS sequence to a time-frequency resource area by using PRS transmission information, and maps the generated PRS sequence to the time-frequency resource area which does not overlap a PRS allocation resource area of a corresponding pico cell or a corresponding macro cell.

In a heterogeneous communication environment in which multiple macro cells exist and each of the particular macro cells includes non-macro cells (or non-macro BSs), such as one or more pico cells and the like, having forms different from those of the macro cells, the term “corresponding macro cell” may refer to a macro cell including a pico cell which transmits a PRS, or another macro cell adjacent to the pico cell which transmits a PRS. The term “corresponding pico cell” may refer to a pico cell included in a macro cell which transmits a PRS, or a pico cell included in another macro cell adjacent to the macro cell which transmits a PRS, in the heterogeneous communication environment.

The PRS resource allocator 1220 according to an exemplary embodiment of the present invention may employ the schemes as described above with reference to FIG. 6 to FIG. 9, as a scheme for allocating a PRS sequence to a time-frequency resource area so as to prevent overlap of a PRS transmission pattern of the corresponding macro cell (or the corresponding pico cell) with a PRS transmission pattern of the pico cell (or the macro cell).

Specifically, the schemes as described above with reference to FIG. 6 to FIG. 9 may include: 1) the first embodiment, in which the PRS transmission parameters of the pico cell are defined independently of those of the corresponding macro cell and then are used; 2) the second embodiment, in which the pico cell allocates (or maps) a PRS sequence thereof to only subframes in which the corresponding macro cell does not actually transmit a PRS within the range of PRS transmission subframes of the corresponding macro cell; 3) the third embodiment, in which the pico cell divides, in time, PRS transmission subframes defined in the corresponding macro cell according to the scheme of the related art and uses the divided PRS transmission subframes; and 4) the fourth embodiment, in which the pico cell divides a frequency band in a unit of RB with respect to PRS transmission subframes defined in the corresponding macro cell, according to the scheme of the related art, and allocates or maps a PRS sequence thereof so as to prevent overlap between a PRS pattern thereof and that of the corresponding macro cell. However, the present invention is not limited to this configuration. In order to avoid redundancy of description, a detailed description thereof will be omitted.

Also, as illustrated in FIG. 12, the PRS resource allocator 1220 may operate while being interlocked with an RE mapper which is an element of the BS apparatus. According to circumstances, the PRS resource allocator 1220 and the RE mapper may be integrated into a single unit.

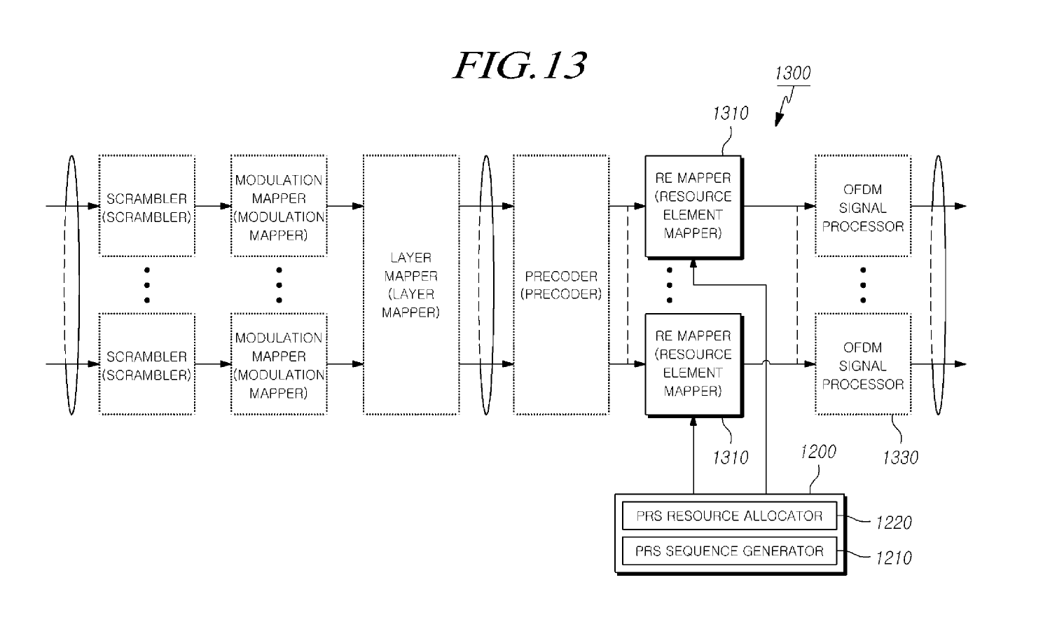

Such an overall BS apparatus or a device for transmitting a PRS will be described below in more detail with reference to FIG. 13.

FIG. 13 is a block diagram illustrating functional blocks of a device 1300 for transmitting a PRS, to which exemplary embodiments of the present invention are applied.

Referring to FIG. 13, the device 1300 for transmitting a PRS according to an exemplary embodiment of the present invention may include an RE mapper 1310, an apparatus 1200 for allocating a PRS according to an exemplary embodiment of the present invention, and an OFDM signal processor 1330. The apparatus 1200 for allocating a PRS may include a PRS sequence generator 1210 and a PRS resource allocator 1220.

Meanwhile, as illustrated by a dotted line, the device 1300 for transmitting a PRS may additionally include configurations for transmitting data or multiple pieces of information other than a PRS. Specifically, the device 1300 for transmitting a PRS additionally may include a scrambler, a modulation mapper, a layer mapper, a precoder, an OFDM signal generator and the like, which are elements of a basic transmission device in the BS. However, in exemplary embodiments of the present invention, this configuration is not definitely required.

Meanwhile, the device 1300 for transmitting a PRS may be implemented within the communication system of the BS 10 illustrated in FIG. 1, or may be implemented in association with the communication system of the BS 10.

A basic operation of the device 1300 for transmitting a PRS is as follows. Bits which go through channel coding and are input in the form of codewords in downlink, are scrambled by a scrambler and are then input to the modulation mapper. The modulation mapper modulates the scrambled bits to a complex modulation symbol, and the layer mapper maps the complex modulation symbol to one transmission layer or multiple transmission layers. Then, the precoder precodes the complex modulation symbol on each transmission channel of an antenna port. Then, the RE mapper maps a complex modulation symbol for each antenna port to a relevant resource element.

Meanwhile, according to an exemplary embodiment of the present invention, when the PRS sequence generator 1210 generates a PRS sequence and delivers the generated PRS sequence to the PRS resource allocator 1220, the PRS resource allocator 1220 allocates a PRS sequence of each pico cell or each macro cell to a time-frequency region according to each of the schemes as in the first to fourth embodiments of the present invention as described above, solely or in such a manner as to be interlocked with the RE mapper, and multiplexes the PRS sequence of each pico cell or each macro cell, which is allocated to the time-frequency region, with a BS transmission frame at a predetermined frame timing.

At this time, RSs including a PRS and control signals may be first allocated to REs, and data received from the precoder may be allocated to the remaining REs. However, the present invention is not limited to this configuration.

Thereafter, the OFDM signal processor 1330 generates a complex time domain OFDM signal in the time-frequency resource region which is allocated the PRS sequence. Next, the generated complex time domain OFDM signal is transmitted through the relevant antenna port.

According to an embodiment of the present invention, the apparatus 1200 for allocating a PRS and the RE mapper 1310 may be integrated, in hardware or software, into a single unit.

Particularly, the PRS resource allocator 1220 of the apparatus 1200 for allocating a PRS may be integrated with the RE mapper 1310 of the device 1300 for transmitting a PRS, into a single unit. In this case, the single unit may be expressed as the PRS resource allocator 1220 or the RE mapper 1310.

The signal generation structure of the downlink physical channel of the wireless communication system, to which exemplary embodiments of the present invention are applied, has been described with reference to FIG. 13. However, the present invention is not limited to this signal generation structure. Specifically, in the signal generation structure of the downlink physical channel of the wireless communication system, to which exemplary embodiments of the present invention are applied, other elements may be omitted or added, or may be changed to or replaced by still other elements.

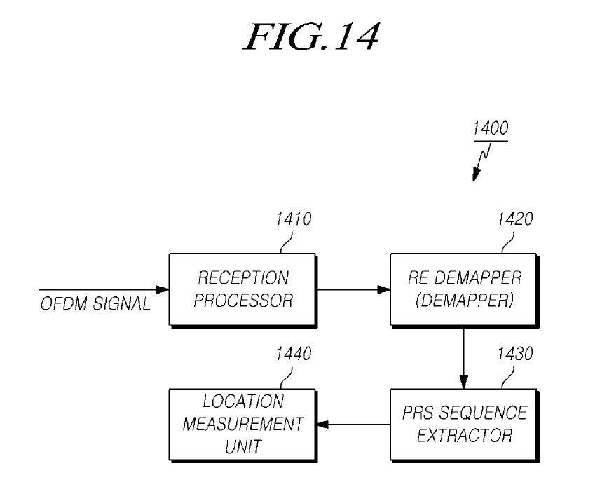

FIG. 14 is a block diagram illustrating a configuration of a device for receiving a PRS transmitted by using a scheme for allocating and transmitting a PRS, according to an exemplary embodiment of the present invention.

Referring to FIG. 14, in the wireless communication system, the device 1400 for receiving a PRS which is included in the UE, may include a reception processor 1410, an RE demapper 1420, a PRS sequence extractor 1430, and a location measurement unit 1440. Although not illustrated, the device 1400 for receiving a PRS may additionally include a decoder, a controller, and the like. At this time, the device 1400 for receiving a PRS may be the UE 10 illustrated in FIG. 1.

The reception processor 1410 receives an OFDM signal transmitted by the device 1300 for transmitting a PRS according to exemplary embodiments of the present invention. Here, the OFDM signal is generated so as to include a PRS sequence which is allocated (or mapped) to a time-frequency resource area so as to prevent overlap between a resource area, which is allocated a PRS sequence of a corresponding pico cell (or a corresponding macro cell) matched to a macro cell (or a pico cell), and a resource area which is allocated a PRS sequence of the macro cell (or the pico cell).

Then RE demapper 1420 demaps information allocated to each RE, from the received OFDM signal. The multiple pieces of demapped information may include various RSs such as a PRS of each of one or more pico cells or macro cells as well as control information and data information.

The PRS sequence extractor 1430 may be an apparatus which is included in or is interlocked with the RE demapper 1420. When the RE demapper 1420 demaps information allocated to each RE, it particularly demaps information related to a PRS, and extracts a PRS sequence. Accordingly, the PRS sequence extractor 1430 extracts a PRS sequence each pico cell or each macro cell in the reverse order of a PRS allocation scheme according to one of the schemes as described with reference to FIG. 12.

Also, the location measurement unit 1440 estimates location information of the relevant UE, from PRS sequences of one or more (desirably, three or more) cells extracted by the PRS sequence extractor.

More specifically, the location measurement unit 1440 extracts a PRS sequence of each cell from an OFDM signal transmitted by each cell (desirably, three or more pico cells or macro cells), measures a peak value of autocorrelation through performing the autocorrelation on the extracted PRS sequence and then measures a delay time of the OFDM signal transmitted by each cell, and thereby estimates location information of the UE according to triangulation.

Also, the RE demapper 1420 and the PRS sequence extractor 1430 of the device 1400 for receiving a PRS according to an exemplary embodiment of the present invention may be integrated into a single unit, and may demap information allocated to each RE of a received OFDM signal and then may extract a PRS sequence of a cell which has transmitted the relevant OFDM signal. In this specification, such an element is commonly referred to as the PRS sequence extractor 1430.

As described above, the device 1400 for receiving a PRS forms a pair with the wireless communication system or the device 1300 for transmitting a PRS as described above with reference to FIG. 13, and is a device for receiving a signal transmitted by the device 1300 for transmitting a PRS. Accordingly, the device 1400 for receiving a PRS includes elements for performing a process for processing signals which is reverse to a process in which the device 1300 for transmitting a PRS processes a signal. Accordingly, in this specification, it should be understood that a part of the device 1400 for receiving a PRS which is not described in detail may be replaced on a one-to-one basis by the elements for performing a process for processing signals which is reverse to a process in which the device 1300 for transmitting a PRS processes a signal.

According to the exemplary embodiments of the present invention, it is possible to perform transmission/reception of a PRS, which can minimize the effects of interference between BSs in different forms and thereby can improve accuracy in measuring a location of a UE, in a heterogeneous communication environment where multiple macro cells exist and each of the particular macro cells includes non-macro cells (non-macro BSs), such as one or more pico cells and the like, having forms different from those of the macro cells.

Therefore, it is possible to perform more accurate positioning in the heterogeneous communication environment.

The above description is only an illustrative description of the technical idea of the present invention, and those having ordinary knowledge in the technical field, to which the present invention pertains, will appreciate that various changes and modifications may be made to the embodiments described herein without departing from the essential features of the present invention. Therefore, the embodiments disclosed in the present invention are intended not to limit but to describe the technical idea of the present invention, and thus do not limit the scope of the technical idea of the present invention. The protection scope of the present invention should be construed based on the appended claims, and all of the technical ideas included within the scope equivalent to the appended claims should be construed as being included within the right scope of the present invention.

1. A method for transmitting a Positioning Reference Signal (PRS) in a communication system where one or more macro cells exist and one or more non-macro cells included in the one or more macro cells exist, the method comprising:
generating a PRS sequence unique to each macro cell or each non-macro cell, by each macro cell or each non-macro cell;
allocating or mapping the generated PRS sequence to a time-frequency resource area by using PRS transmission information, by each macro cell or each non-macro cell,
wherein each macro cell or each non-macro cell allocates or maps the generated PRS sequence to the time-frequency resource area which does not overlap a PRS allocation resource area of a corresponding non-macro cell or a corresponding macro cell which is matched to each macro cell or each non-macro cell in which the PRS sequence has been generated;
generating a signal including the allocated or mapped PRS sequence, by each macro cell or each non-macro cell; and
transmitting the generated signal, by each macro cell or each non-macro cell.

2. The method as claimed in claim 1, wherein the macro cell performs macro cell planning by using any one or more of an n number of PRS patterns so as to prevent a neighboring macro cell from having a PRS pattern identical to a PRS pattern of the macro cell, and the non-macro cell performs non-macro cell planning so as to prevent neighboring non-macro cells from having an identical PRS pattern among the n number of PRS patterns.

3. The method as claimed in claim 1, wherein the corresponding macro cell is a macro cell having a cell area, in which a non-macro cell transmitting a PRS is located, or a neighboring macro cell of the non-macro cell transmitting the PRS, and the corresponding non-macro cell is a non-macro cell located within a macro cell transmitting a PRS, or a non-macro cell located within a cell area of a neighboring macro cell of the macro cell transmitting the PRS.

4. The method as claimed in claim 3, wherein, when the non-macro cell transmits the PRS thereof, the non-macro cell defines PRS transmission information of the non-macro cell separately from the PRS transmission information of the corresponding macro cell, and uses the defined PRS transmission information.

5. The method as claimed in claim 4, wherein the PRS transmission information of the non-macro cell comprises a PRS transmission cycle, a PRS transmission offset, and the number of PRS transmission subframes.

6. The method as claimed in claim 3, wherein the corresponding non-macro cell or the corresponding macro cell allocates or maps a PRS sequence to a part or whole of a time-frequency resource area in which the corresponding non-macro cell or the corresponding macro cell performs muting without transmitting a PRS, within PRS transmission subframes configured to cause the corresponding non-macro cell or the corresponding macro cell to transmit the PRS.

7. The method as claimed in claim 3, wherein the non-macro cell and the macro cell divide an N number of consecutive PRS transmission subframes configured to cause the corresponding macro cell and the corresponding non-macro cell to transmit PRSs, and allocate or map the PRS sequences to the divided consecutive PRS transmission subframes.

8. The method as claimed in claim 3, wherein the non-macro cell and the macro cell divide a frequency band for transmitting a PRS and allocate or map the PRS sequences to the divided frequency bands, within a time-frequency resource area configured to cause the corresponding macro cell and the corresponding non-macro cell to transmit PRSs.

9. The method as claimed in claim 8, wherein the frequency band is divided in a unit of one or more resource blocks.

10. A device for transmitting a Positioning Reference Signal (PRS) in a communication system where one or more macro cells exist and one or more non-macro cells located within the one or more macro cells exist, the device comprising:
a PRS sequence generator for generating a PRS sequence unique to each macro cell or each non-macro cell;
a PRS resource allocator for allocating or mapping the generated PRS sequence to a time-frequency resource area by using PRS transmission information, and allocating or mapping the generated PRS sequence to the time-frequency resource area which does not overlap a PRS allocation resource area of a corresponding non-macro cell or a corresponding macro cell which is matched to each macro cell or each non-macro cell in which the PRS sequence has been generated; and
an OFDM processor for generating an OFDM signal including the allocated or mapped PRS sequence and transmitting the generated signal.

11. A method for receiving a Positioning Reference Signal (PRS) by a user equipment in a communication system where one or more macro cells exist and one or more non-macro cells located within the one or more macro cells exist, the method comprising:
receiving and demodulating a signal transmitted while including a PRS sequence mapped to a time-frequency resource region which does not overlap a resource region allocated a PRS sequence of a corresponding macro cell or a corresponding non-macro cell, by the user equipment;
extracting PRS sequences of one or more cells among the one or more macro cells and the one or more non-macro cells, by the user equipment; and
estimating location information of the user equipment by using the extracted PRS sequences, by the user equipment.

12. A device for receiving a Positioning Reference Signal (PRS) in a communication system where one or more macro cells exist and one or more non-macro cells located within the one or more macro cells exist, the device comprising:
a reception processor for receiving a signal transmitted while including a PRS sequence mapped to a time-frequency resource region which does not overlap a resource region allocated a PRS sequence of a corresponding macro cell or a corresponding non-macro cell;
a PRS sequence extractor for demapping information allocated to each resource element of the received signal, and extracting a PRS sequence of a cell which has transmitted the relevant signal; and
a location measurement unit for estimating location information of a user equipment by using the one or more extracted PRS sequences.

13. A heterogeneous communication system having one or more macro cells and one or more non-macro cells located within each macro cell, the heterogeneous communication system comprising:
each of the one or more non-macro cells or each of the one or more macro cells that forms a Positioning Reference Signal (PRS) pattern thereof and transmits a PRS in a time-frequency resource area region which does not overlap a time-frequency resource area in which a corresponding macro cell or a corresponding non-macro cell transmits a PRS, when each of the one or more non-macro cells or each of the one or more macro cells transmits the PRS.
